(19) United States
(12) Patent Application Publication
(10) Pub. No.: US 2005/0024824 A1
(43) Pub. Date: Feb. 3, 2005

(54) Arrangement for cooling heat-generating computer components

(75) Inventor: Michael Riebel, Kissing (DE)

Correspondence Address: COHEN, PONTANI, LIEBERMAN & PAVANE, 551 FIFTH AVENUE, SUITE 1210, NEW YORK, NY, 10176, US

(73) Assignee: Fujitsu Siemens Computers GmbH, Munich (DE)

(21) Appl. No.: 10/901,819

(22) Filed: Jul. 29, 2004

(30) Foreign Application Priority Data
Jul. 30, 2003 (DE) 103 34 798.4

(51) Int. Cl. G06F 1/20

(52) U.S. Cl. 361/687

(57) ABSTRACT

An arrangement for cooling heat-generating computer components in a computer housing with a second housing which has a first cooling fan, and a heat exchanger which is integrated into a coolant flow. The heat exchanger is arranged in or on the second housing in such a way that a cooling air flow flows through the heat exchanger before leaving the second housing.

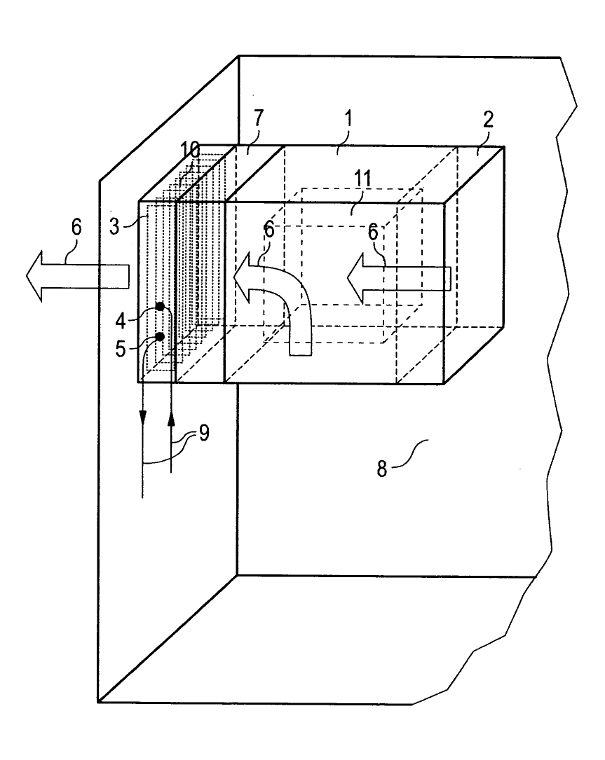

### CROSS-REFERENCE TO RELATED APPLICATIONS

This Patent application claims the priority of German Patent Application No. 103 34 798.4 filed Jul. 30, 2003, the disclosure content of which is hereby incorporated by reference.

### FIELD OF THE INVENTION

The invention relates to an arrangement for cooling heat-generating computer components in a computer housing, with a second housing which has a first cooling fan.

### BACKGROUND OF THE INVENTION

With ever greater increases in power and reductions in size of components, the cooling of computer components, in particular the cooling of the processors of a computer, becomes more and more important.

In this regard, heat sinks with their own cooling fan, which are arranged directly on the heat-generating components, are used for heat-generating components. The heat energy to be dissipated is then given off to the surrounding air in the computer housing. This leads to the air present in the computer housing heating up. A further increase in power of the heat-generating components can consequently be achieved only in conjunction with higher cooling power which applies to the overall system of a computer.

This cooling power is achieved either by means of additional cooling fan cascades, which lead to greater noise generation by the computer, or by using water cooling systems or cooling systems with what are known as heat pipes. The purpose of all these measures is to dissipate the heat to the outside. These arrangements are disadvantageous in that, for example, additional heat sinks are attached to the outside of the housing of the computer and an air flow, which is intended to dissipate the heat from the heat sinks, is induced by additional cooling fans.

### SUMMARY OF THE INVENTION

One object of the invention is to improve heat dissipation with better utilization of resources.

This and other objects are attained in accordance with one aspect of the invention directed to an arrangement for cooling heat-generating computer components in a computer housing, with a second housing which has a first cooling fan, and a heat exchanger, which is integrated into a coolant flow. The heat exchanger is integrated into the second housing in such a way that a cooling air flow flows through the heat exchanger before leaving the second housing.

An advantage of the arrangement according to the invention is the utilization of the existing cooling air flow induced by the first cooling fan, as this transports the housing internal air of the computer housing to the outside through the heat exchanger.

The heat exchanger is advantageously equipped with a connection for coolant supply and a connection for coolant return in order to integrate the heat exchanger into a coolant circuit.

The housing internal air of the computer housing takes up heat energy on its way through the heat exchanger and thus leads to cooling of the coolant flowing through the heat exchanger and circulating in a coolant flow. The heat exchanger advantageously has fins which enlarge its surface area for heat transfer.

This leads to the coolant, which enters at the coolant supply, leaving the heat exchanger again at the coolant return with a lower temperature and cooling of the system consequently being ensured. Additional noise generation is then advantageously simply avoided, as no additional cooling fans are necessary.

Alternatively it is advantageous for extreme requirements, to attach a second cooling fan to the second housing, which fan increases the cooling air flow when a limit temperature is reached. This can be brought about by means of, for example, a temperature-dependent switch which activates the second cooling fan.

### BRIEF DESCRIPTION OF THE DRAWINGS

The invention is explained in greater detail below by means of an illustrative embodiment with reference to a FIGURE.

The FIGURE shows a diagrammatic illustration of the arrangement according to the invention.

### DETAILED DESCRIPTION OF THE DRAWING

A computer housing 8 accommodates therein various heat-generating components (not shown). A second housing 1 within computer housing 8 includes cooling components for dissipating to the outside heat energy accumulated within computer housing 8. The second housing 1 illustrated diagrammatically in the FIGURE shows a first cooling fan 2 arranged on one wall of housing 1 and a heat exchanger 3 arranged on the opposite wall of housing 1. The heat exchanger 3 is flowed through by a coolant which enters the heat exchanger via a coolant supply 4 and leaves the heat exchanger via a coolant return 5. The heat exchanger is part of a cooling circuit in which the coolant is circulating. Other parts of such a cooling circuit are, for example, heat exchangers that are applied to heat generating components arranged in the computer housing. A CPU could be such a heat generating component. The circulation of the cooling fluid, i.e. the coolant, is induced for example by a fluid pump or simply by the temperature differences between the hot part of the cooling circuit and the cold part of the cooling circuit. The hot part of the cooling circuit is the heat exchanger applied to the CPU. The cold part is the heat exchanger applied in the cooling air flow. With the present invention, the cooling effect is optimized without producing a greater amount of noise by using components, especially fans, that are already utilized in every computer housing.

A cooling air flow 6, induced by the cooling fan 2, flows through the heat exchanger 3, which leads to a transfer of the heat energy from the coolant to the cooling air flow 6. This occurs when the temperature of the warm air from the computer housing is cooler than the temperature of the coolant at coolant supply 4. The temperature of the coolant at the coolant return 5 is thus reduced in relation to the temperature of the coolant at the coolant supply 4. The amount of energy taken up from the air depends on the difference between the temperature of the air and the temperature of the coolant flowing to the heat exchanger. By virtue of the utilization of the existing first cooling fan 2 by integrating the heat exchanger 3 into the cooling air flow 6 of the cooling fan 2 of the second housing 1, additional noise generation by further cooling fans is avoided.

The heat exchanger 3 is arranged on the second housing 1 in such a way that it replaces an entire housing wall of the second housing 1. This means that the whole cooling air flow 6 is used optimally, without having to attach special additional devices to the second housing 1. The heat exchanger 3 can be included alternatively as the sole heat exchanger 3 in a coolant flow or as an additional heat exchanger in the coolant flow.

In order to adapt the cooling capacity to more extreme conditions, a second cooling fan 7 is arranged on the second housing, which, when required, that is when a given temperature limit value is reached, increases the cooling air flow 6 and thus also the heat energy dissipated. This can be brought about by means of a temperature-dependent switch (not shown) which activates the second cooling fan 7 at a limit temperature. The arrangement of the two cooling fans 2, 7 in a “series connection”, one behind another in the cooling air flow 6 as shown in the FIGURE, makes it possible alternatively to increase the cooling air flow in an advantageous way.

To enlarge its surface area, the heat exchanger 3 has a fin-like structure 10 through which the cooling air flow 6 passes.

By virtue of its arrangement as a housing wall of the second housing 1, the heat exchanger 3 is advantageously arranged on a housing wall of a computer housing 8 in such a way that the cooling air flow 6 leaves the computer housing 8 after leaving the heat exchanger 3. The heat energy is thus dissipated to the outside, outside the computer housing 8.

A power supply unit 11 is advantageously integrated into the second housing 1, the cooling of which unit is likewise achieved by means of the arrangement.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. Arrangement for cooling heat-generating computer components in a computer housing (8), comprising:
a second housing (1) contained in the computer housing,
a first cooling fan (2) arranged in/on the second housing,
a heat exchanger (3), which is integrated into a coolant flow (9), arranged in/on the second housing (1) such that a cooling air flow (6) flows through the heat exchanger (3) before leaving the second housing (1).

2. Arrangement according to claim 1, wherein the heat exchanger (3) forms one housing wall of the second housing (1).

3. Arrangement according to claim 1, wherein a second cooling fan (7), which is activated at a predetermined temperature, is arranged in/on the second housing (1).

4. Arrangement according to claim 1, wherein the heat exchanger (3) has a fin-like structure so that the surface area of the heat exchanger (3) is enlarged.

5. Arrangement according to claim 1, wherein the heat exchanger (3) is arranged on a housing wall of the computer housing (8) in such a way that the cooling air flow (6) leaves the computer housing (8) after passing through the heat exchanger (3).

6. Arrangement according to claim 1, wherein the second housing (1) contains a power supply unit for the computer.

7. Arrangement according to claim 1, wherein the heat exchanger has a connection for coolant supply (4) and a connection for coolant return (5).
